(19) United States
(12) Patent Application Publication
(10) Pub. No.: US 2025/0095226 A1
(43) Pub. Date: Mar. 20, 2025

(54) IMAGE GENERATION WITH ADJUSTABLE COMPLEXITY

(71) Applicant: ADOBE INC., SAN JOSE, CA (US)

(72) Inventors: Adrian-Stefan Ungureanu-Contes, Bucuresti (RO); Marian Lupascu, Bucuresti (RO); Vlad-Constantin Lungu-Stan, Bucuresti (RO); Ionut Mironicä, Bucharest (RO); Vineet Batra, Delhi (IN)

(21) Appl. No.: 18/884,787

(22) Filed: Sep. 13, 2024

Related U.S. Application Data
(60) Provisional application No. 63/583,380, filed on Sep. 18, 2023.

(30) Foreign Application Priority Data
Sep. 15, 2023 (RO) A/00507/2023

(51) Int. Cl. G06T 11/00; G06F 3/04847

(52) U.S. Cl. CPC G06T 11/00; G06F 3/04847; G06T 2200/24; G06T 2210/32; G06T 2210/36

(57) ABSTRACT

A method, apparatus, non-transitory computer readable medium, and system for generating images with an adjustable level of complexity includes obtaining a content prompt, a style prompt, and a complexity value. The content prompt describes an image element, the style prompt indicates an image style, and the complexity value indicates a level of influence of the style prompt. Embodiments then generate, using an image generation model, an output image based on the content prompt, the style prompt, and the complexity value, wherein the output image includes the image element with a level of the image style based on the complexity value.

### CROSS-REFERENCE TO RELATED APPLICATION

This U.S. non-provisional application claims priority under 35 U.S.C. § 119 to U.S. Provisional Patent Application No. 63/583,380 filed on Sep. 18, 2023 in the United States Patent and Trademark Office, as well as to Romanian Patent Application A/00507/2023 filed on Sep. 15, 2023 in the State Office for Inventions and Trademarks (OSIM), the disclosures of which are incorporated by reference herein in their entirety.

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image processing techniques are also used for image generation. For example, machine learning (ML) techniques have been applied to create generative models that can produce new image content. One use for generative AI is to create images based on an input prompt. This task is often referred to as a “text to image” task or simply “text2img”. Some models such as GANs and Variational Autoencoders (VAEs) employ an encoder-decoder architecture with attention mechanisms to align various parts of text with image features. Newer approaches such as denoising diffusion probabilistic models (DDPMs) iteratively refine generated images in response to textual prompts. These models are typically used to produce images in the form of pixel data, which represents images as a matrix of pixels, where each pixel includes color information.

### SUMMARY

Embodiments of the present inventive concepts include systems and methods for image generation with controllable complexity. In some cases, pretrained image generation models such as diffusion-based models may be biased towards producing realistic images. This behavior can be undesirable for some tasks, such as generating vector images. Vector format images are images that are represented as paths and shapes, and excessive detail from realistic images can complicate their conversion to vector format. To address this, embodiments enable the production of images with adjustable complexity.

The system includes an image generation model incorporating a diffusion prior model that generates a style embedding and a diffusion model that synthesizes an image based on the style embedding. The style embedding encodes visual characteristics such as flat colors, simple shapes, and lowered high-frequency detail. The style embedding may also encode other characteristics associated with one or more image categories. The image generation model selectively applies the style embedding to one or more layers of the diffusion model during image synthesis to adjust the strength of the style. For instance, when a low complexity level is requested, the style embedding is applied to more layers of the model, ensuring that the low-complexity characteristics are prominently reflected in the final image.

A method, apparatus, non-transitory computer readable medium, and system for image generation are described. One or more aspects of the method, apparatus, non-transitory computer readable medium, and system include obtaining a content prompt, a style prompt, and a complexity value, wherein the content prompt describes an image element, the style prompt indicates an image style, and the complexity value indicates a level of influence of the style prompt; and generating, using an image generation model, an output image based on the content prompt, the style prompt, and the complexity value, wherein the output image includes the image element with a level of the image style based on the complexity value.

A method, apparatus, non-transitory computer readable medium, and system for image generation are described. One or more aspects of the method, apparatus, non-transitory computer readable medium, and system include obtaining a content prompt, a style prompt, and a complexity value, wherein the content prompt describes an image element, the style prompt indicates an image style, and the complexity value indicates a level of influence of the style prompt and generating an output image that includes the image element with a level of the image style based on the complexity value.

An apparatus, system, and method for image generation are described. One or more aspects of the apparatus, system, and method include at least one processor; at least one memory storing instructions executable by the at least one processor; and an image generation model comprising parameters stored in the at least one memory and configured to generate an output image depicting an image element from a content prompt based on the content prompt, a style prompt indicating an image style, and a complexity value that indicates a level of influence of the style prompt, wherein the output image has a level of the image style based on the complexity value.

### BRIEF DESCRIPTION OF THE DRAWINGS

FIG. 1 shows an example of a design personalization system according to aspects of the present disclosure.

FIG. 2 shows an example of a design personalization apparatus according to aspects of the present disclosure.

FIG. 3 shows an example of a guided latent diffusion model according to aspects of the present disclosure.

FIG. 4 shows an example of a U-Net according to aspects of the present disclosure.

FIG. 5 shows an example of a pipeline for generating images with adjustable complexity according to aspects of the present disclosure.

FIG. 6 shows an example of image style categories according to aspects of the present disclosure.

FIG. 7 shows an example of style embedding application approaches according to aspects of the present disclosure.

FIG. 8 shows an example of a complexity slider element according to aspects of the present disclosure.

FIG. 9 shows an example of output results with different complexities according to aspects of the present disclosure.

FIG. 10 shows an example of a method a diffusion process according to aspects of the present disclosure.

FIG. 11 shows an example of a method for image processing according to aspects of the present disclosure.

FIG. 12 shows an example of an algorithm for training ML models according to aspects of the present disclosure.

FIG. 13 shows an example of a method for training a diffusion model according to aspects of the present disclosure.

FIG. 14 shows an example of a pipeline for training an image generation model according to aspects of the present disclosure.

FIG. 15 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process. ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Generative models in ML are algorithms designed to generate new data samples that resemble a given dataset. Generative models are used in various fields, including image generation. They work by learning patterns, features, and distributions from a dataset and then using this understanding to produce new, original outputs.

In some cases, generative models tend to produce realistic outputs with a lot of details. This can be useful, but it may not always fit the user's needs. For example, users might want to create images with simpler designs, such as cartoon-style images or images that can be easily converted into vector format. For vector conversion tasks, it can be useful to balance how “vectorizable” an image is. Vectorizable images are images that have attributes that enable the image to be efficiently and accurately translated from pixel data to vector image format. Such attributes include, but are not limited to, flat or solid color regions, clearly defined shapes or boundaries, and the absence of gradient transitions or fuzzy edges. Herein, highly “vectorizable” outputs indicate a high level of style has been applied resulting in a lower complexity. However, it will be appreciated that the embodiments described herein are applicable to other downstream tasks that require variable complexity.

Traditional approaches for generating vectorizable content often involve transforming or adapting existing images to make them suitable for vectorization. These methods rely on estimation-based processes that can be computationally expensive and do not directly generate new vectorized content. More recent techniques have explored the use of generative models, such as diffusion models, to produce vectorized images directly. However, these methods tend to produce overly simplistic outputs. They do not provide a means for controlling the level of complexity.

Some conventional methods focus on generating images that can be rasterized or converted into vector formats, but they tend to produce overly detailed outputs. This high level of detail can make the vectorization process difficult and ineffective. For example, the outputs from such models can have too many anchor points or complex textures that do not translate well into vector paths.

Embodiments of the present disclosure improve the accuracy of generated images by generating images with an explicitly controllable amount of complexity. Embodiments include an image generation model that incorporates a diffusion prior model, which generates a style embedding that encodes visual characteristics such as flat colors, simple shapes, and reduced high-frequency details. This style embedding is then used by a diffusion model to synthesize the final image. By selectively applying the style embedding to various layers of the diffusion model during image synthesis, the system can adjust the complexity of the generated image according to the user's specifications. For example, when a user desires a simpler image with fewer details, the style embedding can be applied to more layers of the model, ensuring that the output is well-suited for tasks like vectorization or achieving a particular artistic style.

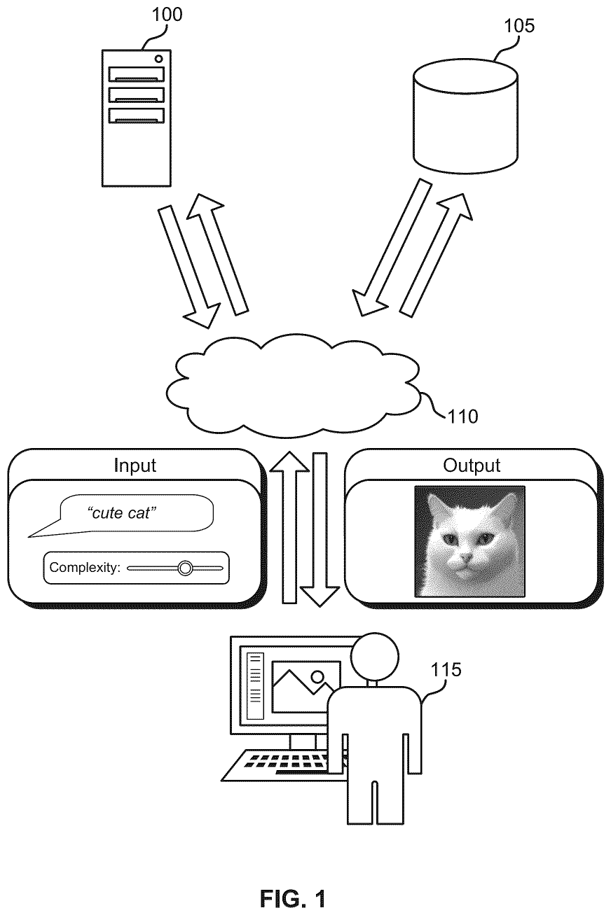

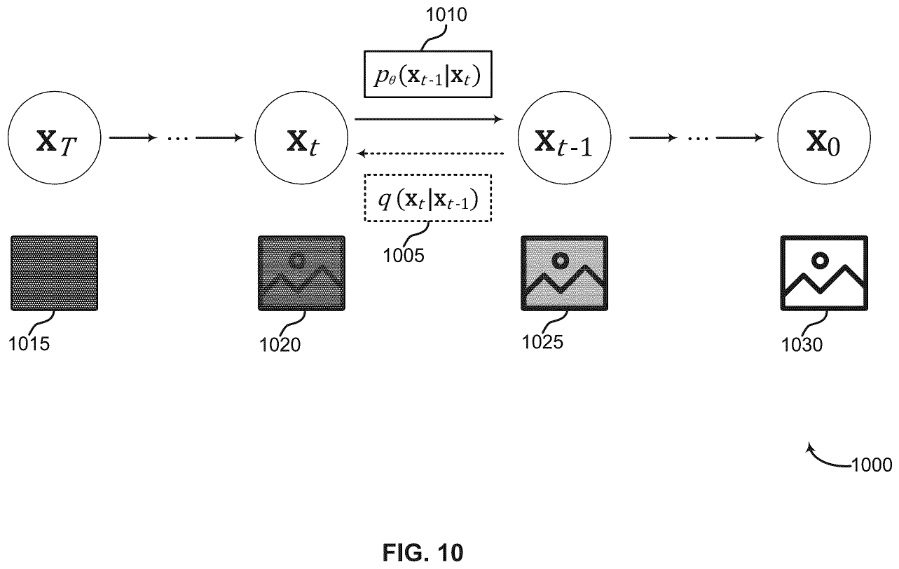

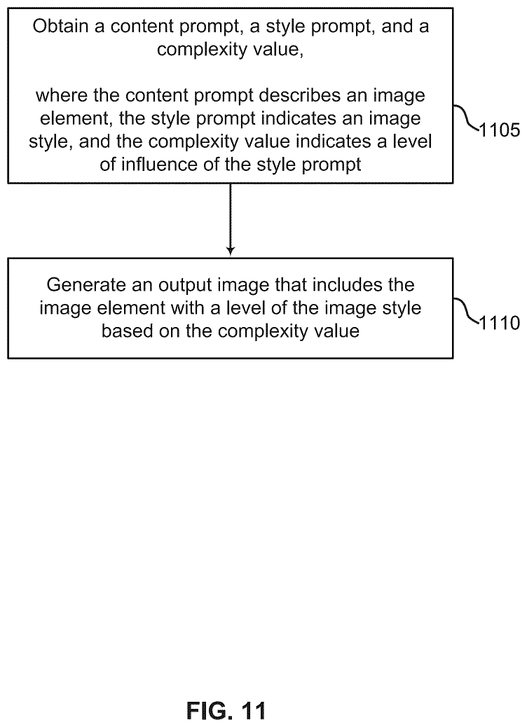

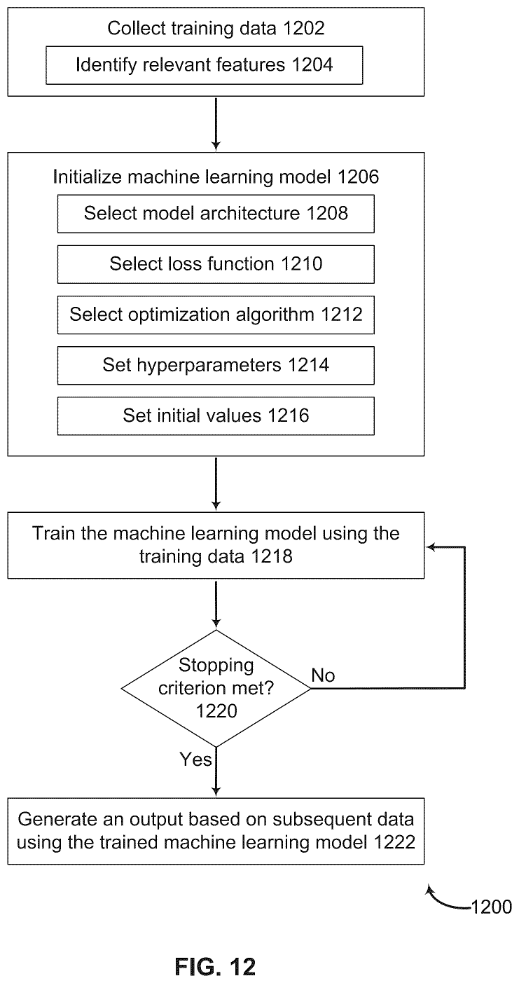

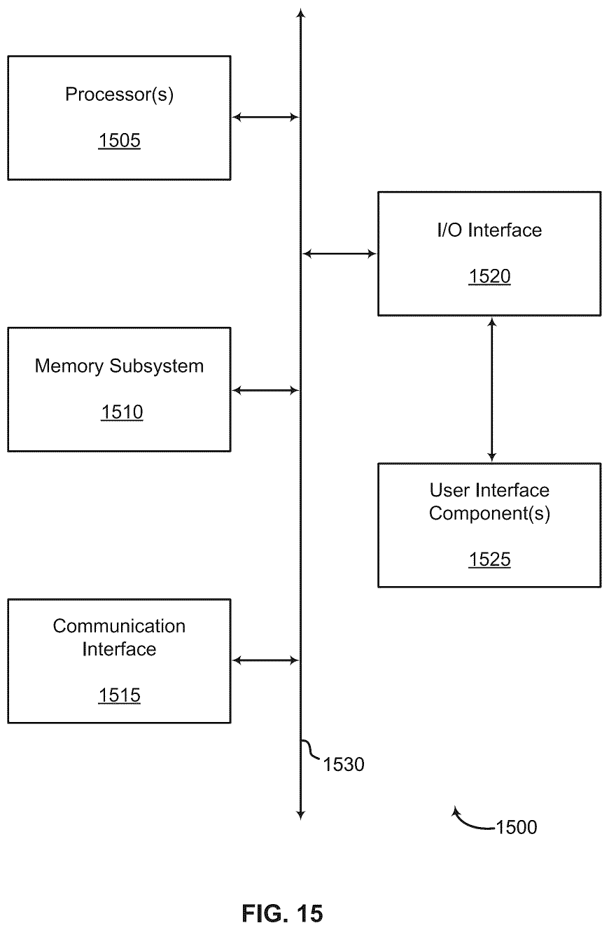

A design personalization system is described with reference to FIGS. 1-9. Methods for generating images with a controllable level of complexity are described with reference to FIGS. 10-11. Methods for training a machine learning model configured to generate the images are described with reference to FIGS. 12-14. A computing device configurable to implement a design personalization apparatus is described with reference to FIG. 15.

### Design Personalization System

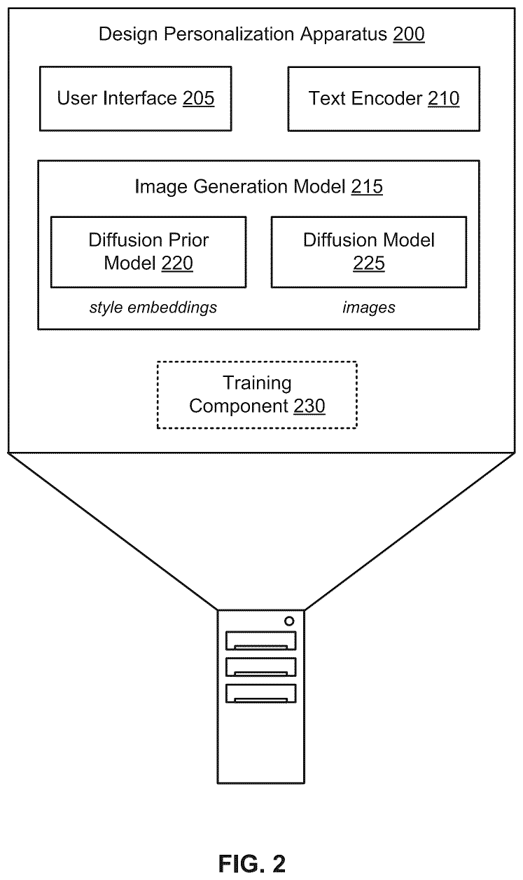

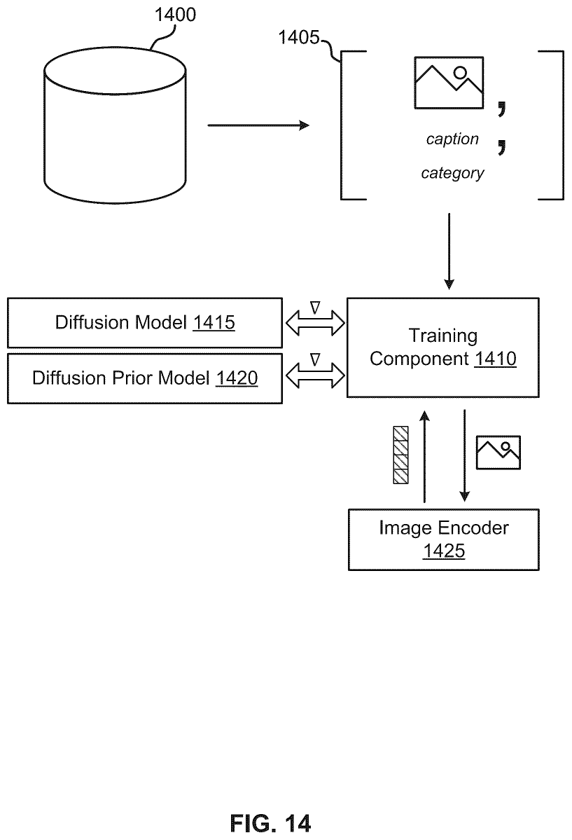

FIG. 1 shows an example of a design personalization system according to aspects of the present disclosure. The example shown includes design personalization apparatus 100, database 105, network 110, and user 115. Design personalization apparatus 100 is an example of, or includes aspects of, the corresponding element described with reference to FIG. 2. Database 105 is an example of, or includes aspects of, the corresponding element described with reference to FIG. 14.

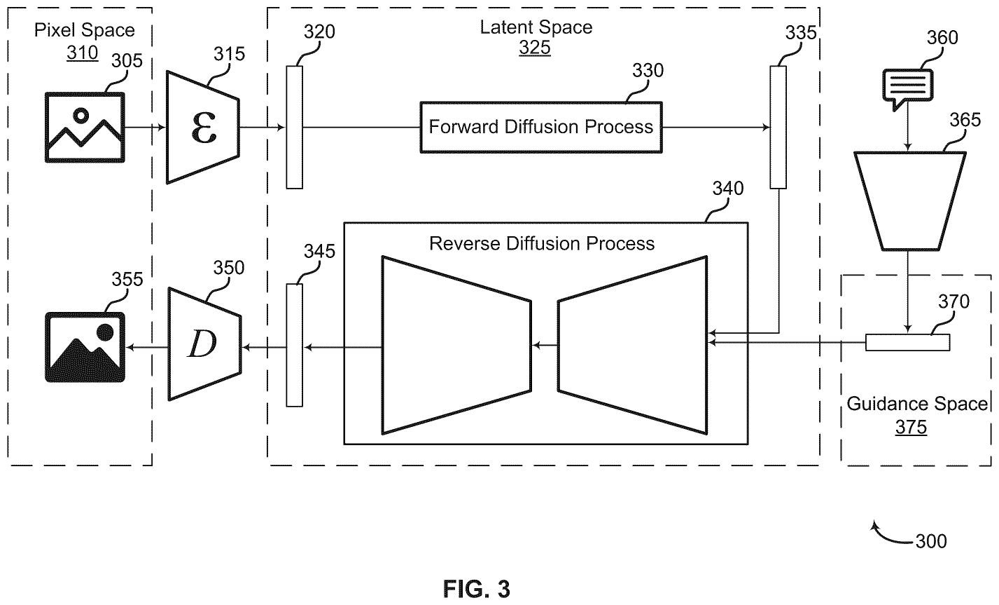

In an example, user 115 provides a text prompt and a complexity value as input to the system. The text prompt describes the desired content in a generated image, and the complexity value indicates a desired level of complexity in the generated image. The design personalization apparatus 100 encodes the text prompt to obtain a text embedding, and additionally generates a style embedding. The style embedding may be based at least in part on the text prompt. In some cases, the style embedding is based on a selected image category. Then, the design personalization apparatus 100 generates an image using the text embedding and the style embedding as a generation condition, and provides the image to user 115. Additional detail about the generation process is described with reference to FIGS. 3-5, 7, and 10.

In some cases, one or more components of design personalization apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the design personalization system. For example, database 105 may store previously generated images, machine learning model parameters, pre-computed style embeddings, training data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in the database. In some cases, a user interacts with the database controller. In other cases, the database controller may operate automatically without user interaction.

Network 110 is configured to facilitate the transfer of information between design personalization 100, database 105, and user 115. In some cases, network 100 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of a design personalization apparatus 200 according to aspects of the present disclosure. The example shown includes design personalization apparatus 200, user interface 205, text encoder 210, image generation model 215, and training component 230. Design personalization apparatus 200 is an example of, or includes aspects of, the corresponding element described with reference to FIG. 1.

Components of design personalization apparatus 200, such as text encoder 210 and image generation model 215, may include an artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

User interface 205 enables a user to interact with the design personalization apparatus 200. In some embodiments, the user interface 205 may include an audio device, such as an external speaker system, an external display device such as a display screen, or an input device (e.g., remote control device interfaced with the user interface 205 directly or through an IO controller module). In some cases, a user interface 205 may be a graphical user interface (GUI). For example, the GUI may be incorporated as part of a web application.

According to some aspects, the design personalization system identifies an image category, where the output image is generated based on the image category. For example, the image category may be selected from a list of image categories or extracted from an input text prompt. In some aspects, the complexity value is received via a slider element of a user interface 205.

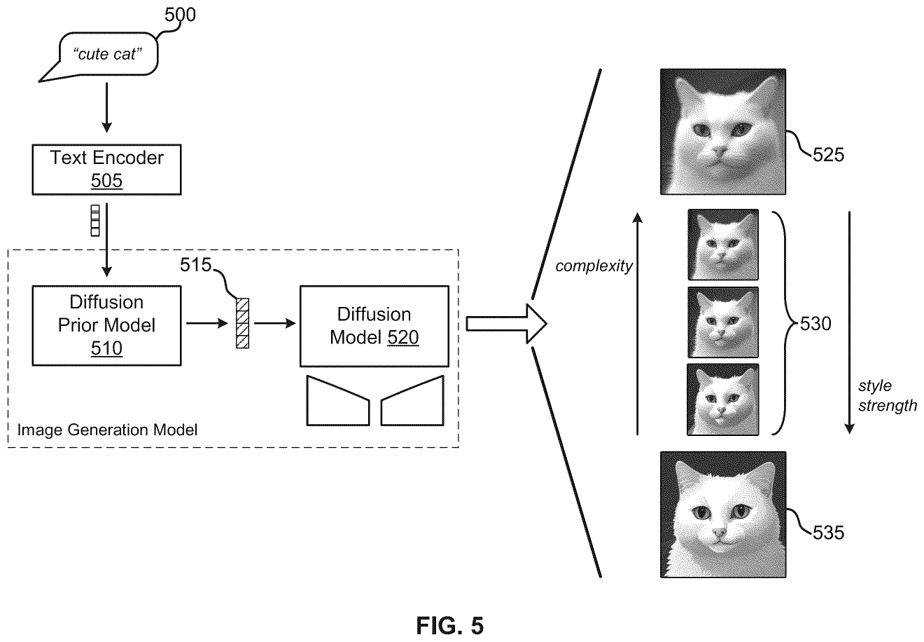

Text encoder 210 is configured to generate a text embedding, which a data-rich vector representation of text designed to capture semantic meaning. Embodiments of text encoder 210 include a transformer-based model, such as Flan-T5. A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes an attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a. Text encoder 210 is an example of, or includes aspects of, the corresponding element described with reference to FIG. 5.

Image generation model 215 generates a synthetic image from the text embedding produced by text encoder 210. According to some aspects, image generation model 215 generates an output image that includes the image element with a level of the image style based on an input complexity value. In some examples, image generation model 215 determines a set of layers of the image generation model 215 to use for generating the output image based on the complexity value, where the output image is generated using the determined set of layers. Image generation model 215 is an example of, or includes aspects of, the corresponding element described with reference to FIG. 5.

In one aspect, image generation model 215 includes diffusion prior model 220 and diffusion model 225. Diffusion prior model 220 generates an image embedding from the text embedding produced by the text encoder 210. This image embedding is then used to condition the generation of the output image, performed by diffusion model 225.

A training process configures the diffusion prior model 220 to generate a prior embedding, sometimes referred to as a “style embedding” herein, that is used to condition the generation process of the diffusion model 225. In some embodiments, the diffusion prior model 220 is trained to generate embeddings that condition the diffusion model 225 to generate low-complexity or “vectorizable” images. For example, the diffusion prior model 220 may be trained on training data that includes highly vectorizable images. Therefore, when given a text prompt, the diffusion prior model 220 generates image embeddings in a multimodal space (e.g., a text-image embedding space such as a CLIP space), such that the image embeddings represent vectorizable characteristics that are transferred to the diffusion model 225 during generation.

Contrastive Language-Image Pre-Training (CLIP) is a neural network that is trained to efficiently learn visual concepts from natural language supervision. CLIP can be instructed in natural language to perform a variety of classification benchmarks without directly optimizing for the benchmarks' performance, in a manner building on “zero-shot” or zero-data learning. CLIP can learn from unfiltered, highly varied, and highly noisy data, such as text paired with images found across the Internet, in a similar but more efficient manner to zero-shot learning, thus reducing the need for expensive and large labeled datasets. A CLIP model can be applied to nearly arbitrary visual classification tasks so that the model may predict the likelihood of a text description being paired with a particular image, removing the need for users to design their own classifiers and the need for task-specific training data. For example, a CLIP model can be applied to a new task by inputting names of the task's visual concepts to the model's text encoder. The model can then output a linear classifier of CLIP's visual representations. Embodiments of diffusion prior model 220 generate a CLIP image embedding from a corresponding CLIP text embedding through a diffusion process. Diffusion prior model 220 is an example of, or includes aspects of, the corresponding element described with reference to FIGS. 5 and 14.

Training component 230 updates parameters of the image generation model 215. During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times. Training component 230 is an example of, or includes aspects of, the corresponding element described with reference to FIG. 14. In at least one embodiment, training component 230 is implemented on an apparatus other than design personalization apparatus 200.

FIG. 3 shows an example of a guided latent diffusion model 300 according to aspects of the present disclosure. The guided latent diffusion model 300 depicted in FIG. 2 is an example of, or includes aspects of, the diffusion prior model and the diffusion model described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Nexₜ, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340.

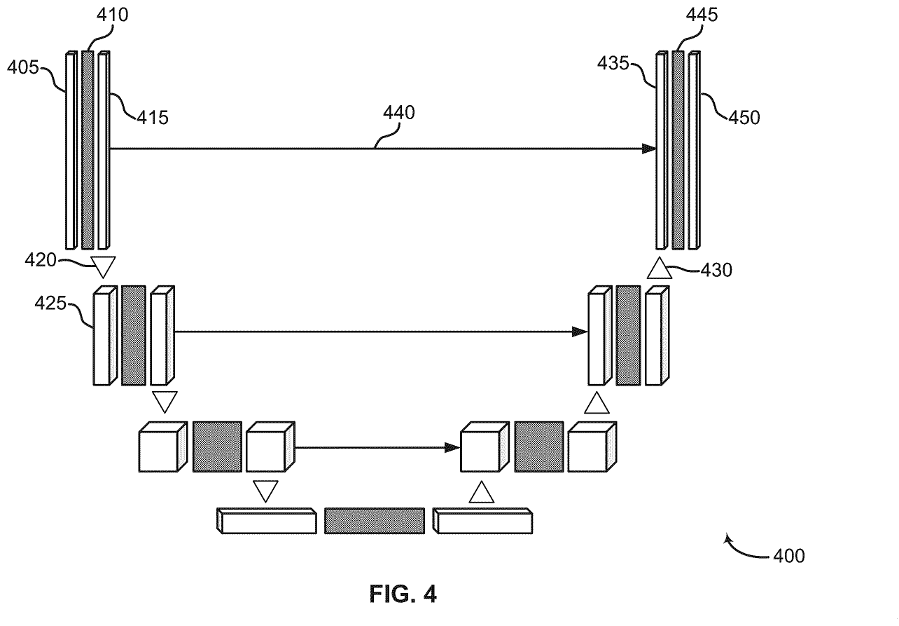

FIG. 4 shows an example of a U-Net 400 according to aspects of the present disclosure. The U-Net 400 depicted in FIG. 4 is an example of, or includes aspects of, the architecture used within the reverse diffusion process described with reference to FIG. 2.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 features have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having the same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415.

FIG. 5 shows an example of a pipeline for generating images with adjustable complexity according to aspects of the present disclosure. The example shown includes text prompt 500, text encoder 505, diffusion prior model 510, style embedding 515, diffusion model 520, image with no application of style embedding 525, images with partial application of style embedding 530, and image with full application of style embedding 535.

Text encoder 505 is an example of, or includes aspects of, the corresponding element described with reference to FIG. 2. Diffusion prior model 510 is an example of, or includes aspects of, the corresponding element described with reference to FIGS. 2 and 14. Diffusion model 520 is an example of, or includes aspects of, the corresponding element described with reference to FIG. 2.

In this example, the system obtains a text prompt 500. The system may do so via a user interface as described with reference to FIG. 2. Then, text encoder 505 encodes the text prompt to obtain a text embedding, which is input to the diffusion prior model 510. The diffusion prior model 510 is trained to translate text embeddings into image embeddings in a multimodal embedding space. This translation may be done, for example, by a reverse diffusion process as described with reference to FIGS. 3-4. For example, the diffusion prior model 510 may perform reverse diffusion on a noise latent using the text embedding as guidance via a cross-attention mechanism between the noise latent and the text embedding. The image embeddings are tensors that encode visual characteristics for a desired image. For embodiments described herein, the image embeddings generally encode a low-complexity style and are referred to more specifically as “style embeddings.”

The diffusion prior model 510 generates style embedding 515 from the text embedding. The style embedding 515 is input to diffusion model 520 as a control guidance. Diffusion model 520 then generates an output image using the style embedding 515 at one or more layers of the U-Net of the diffusion model 520. According to some aspects, the one or more layers of the U-Net in which the style embedding 515 is applied are selected according to an input complexity value. For example, if a user specifies a low complexity value, the image generation model may apply the style embedding 515 at relatively many layers of the U-Net of diffusion model 520. For the lowest possible complexity, for example, the image generation model may apply style embedding 515 at every layer of diffusion model 520, resulting in the image with full application of style embedding 535. For higher complexity values, the image generation model may apply the style embedding 515 at relatively few layers of the U-Net of diffusion model 520. For example, for the highest possible complexity, the image generation model may apply style embedding 515 to none of the layers of diffusion model 520, resulting in the image with no application of style embedding 525. For intermediate complexity values, the image generation model may produce images with partial application of style embedding 530.

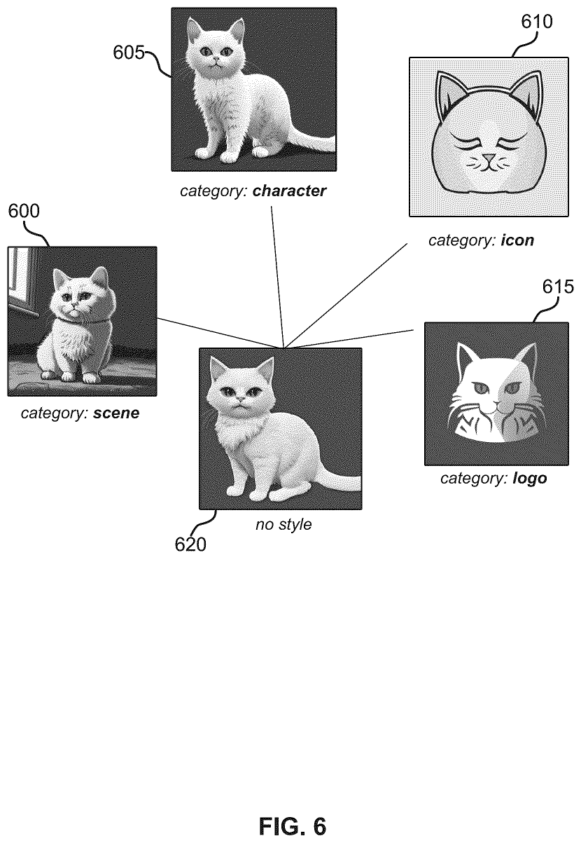

FIG. 6 shows an example of image style categories according to aspects of the present disclosure. The example shown includes output image with scene category 600, output image with character category 605, output image with icon category 610, output image with logo category 615, and output image with no application of style embedding 620.

In some embodiments, the design personalization system obtains an image style category along with the input text prompt and complexity value. The image style category may be specified a user through a GUI. For example, the user may select an image style category from a list of available image style categories or specify the image style category in the text prompt. If specified outside of the text prompt, the design personalization system may append the word(s) corresponding to the image style category to the text prompt.

In the example shown in FIG. 6, if a “scene” category is specified, the image generation model may generate output image with scene category 600. For example, the output image may include additional background elements commonly associated with a scene. If a “character” category is specified, the image generation model may generate output image with character category 605, which focuses on only the content elements described in the original text prompt. If an “icon” category is specified, the image generation model may generate output image with icon category 610, which includes simplified lines and shapes associated with icons. If a “logo” category is described, the image generation model may generate output image with logo category 615, which is similar to the “icon” style but may include bright colors and contrast associated with logos. The output image with no application of style embedding 620 depicts a result corresponding to no image category with a high complexity value, as evidenced by the details of the fur on the cat.

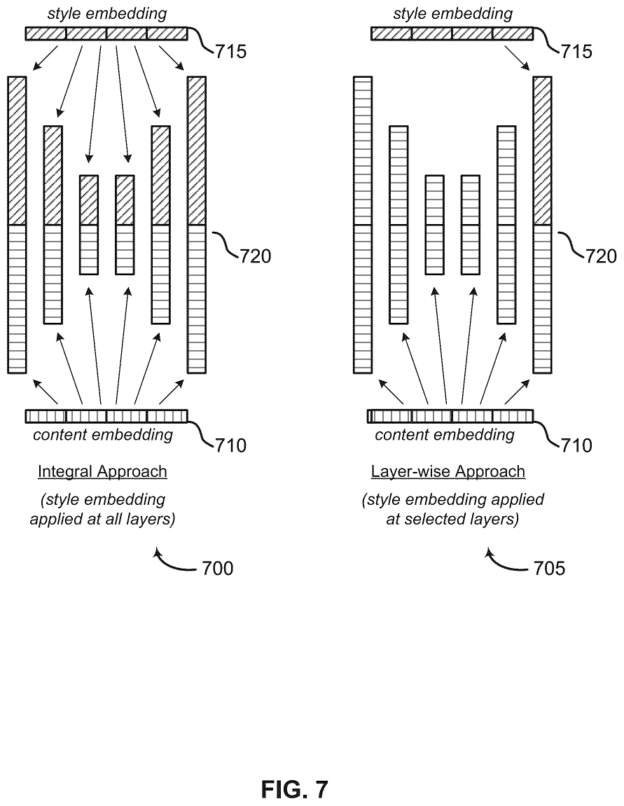

FIG. 7 shows an example of style embedding 715 application approaches according to aspects of the present disclosure. The example shown includes integral approach 700, layer-wise approach 705, text embedding 710, style embedding 715, and U-Net 720.

The integral approach 700 depicts a traditional method for incorporating style into image generation. In this case, style embedding 715 is applied to all layers of U-Net 720 during the generative iterations of the diffusion model, just as the text embedding 710 is. In some cases, this approach can produce images that are overly-simplified, which isn't suitable for all design workflows. Further, this approach does not enable controllable complexity.

The layer-wise approach 705 depicts the methods described herein for incorporating controllable style and complexity. In this case, style embedding 715 is applied to only some layers of U-Net 720 during the generative iterations of the diffusion model. The number of layers is determined by an input complexity value. In some cases, where a lower complexity is desired, the style embedding 715 is applied to a relatively large number of layers of U-Net 720. This is because the style embedding 715 encodes a low-complexity style, which is conducive to vectorization processes. For a higher complexity, style embedding 715 is applied to a fewer number of layers of U-Net 720. In some embodiments, the style embedding 715 is only applied to the decoder (e.g., “upsampling”) layers of the U-Net.

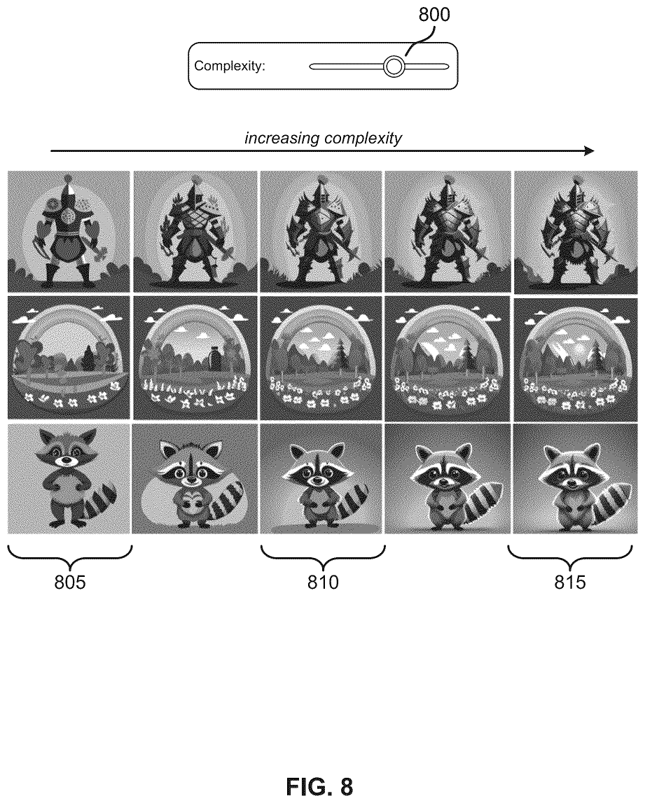

FIG. 8 shows an example of a complexity slider 800 element according to aspects of the present disclosure. The example shown includes complexity slider 800, low complexity images 805, medium complexity images 810, and high complexity images 815.

In some cases, the user can select their desired level of complexity through a graphical user interface (GUI). The GUI may include a complexity slider, such as complexity slider 800 shown here. By adjusting the slider, the user can easily control the complexity of the generated image. According to some aspects, the complexity value chosen by the user is inversely related to the strength with which the style embedding is applied during the image generation process.

When the user selects a low complexity value, the system may apply a style embedding to most if not all decoder layers of an image generation model. This may result in the system generating outputs similar to the leftmost column of images, e.g., low complexity images 805. In this example, the images have a solid color background, rather than a background with varying color gradients. Furthermore, high frequency detail such as detailed fur elements, tree leaves, and armor inlay designs are simplified.

When the user selects a medium complexity value, the system may apply the style embedding to about half of the decoder layers of the image generation model, resulting in images similar to the middle column, e.g., medium complexity images 810. In this example, some high frequency details are restored, such as the knight's shoulder armor designs, additional color bands in the rainbow, and fur details on the raccoon.

When the user selects a high complexity value, the system may apply the style embedding to a low number of layers of the image generation model (e.g., 0-2), resulting in images similar to the rightmost column, e.g., high complexity images 810. In this example, the images depict a high level of detail, including complex color gradients, fuzzy fur, and intricate armor details.

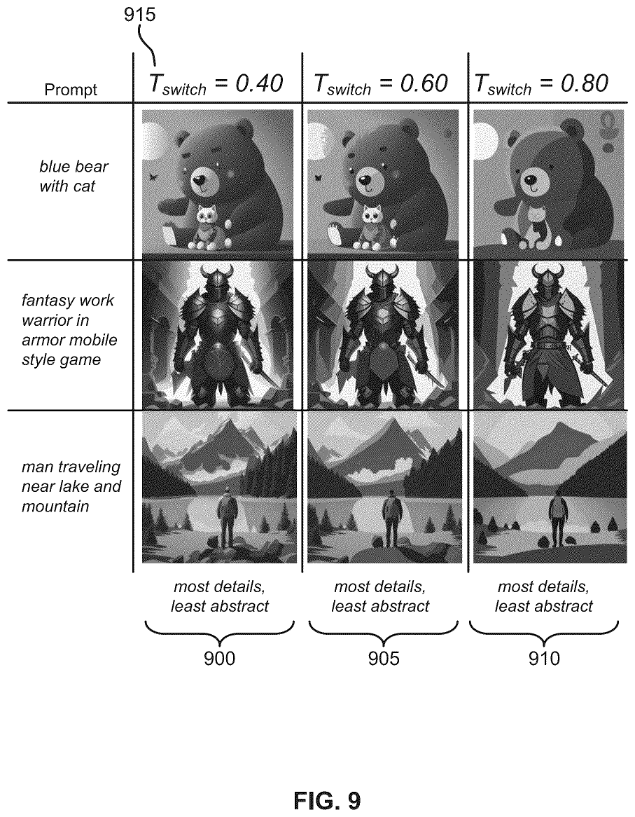

FIG. 9 shows an example of output results with different complexities according to aspects of the present disclosure. The example shown includes high complexity images 900, medium complexity images 905, low complexity images 910, and style strength parameter 915.

Referring to FIG. 8, the complexity slider may determine the value of a style strength parameter 915, also referred to as T_{switch}, which determines the number of layers to which the style embedding is applied. A higher T_{switch} indicates that a higher proportion of layers of the U-Net are conditioned with the style embedding.

Referring to FIG. 9, as shown by the leftmost column including high complexity images 900, a low style strength parameter 915 may correspond to a T_{switch} value of about 0.40. This indicates that about 40% of the available layers in the image generation model that can be conditioned by the style embedding will be conditioned by the style embedding during generation. This configuration causes the image processing system to generate images with fewer vectorizable attributes and higher complexity. For example, the bear in the first row has color gradient elements on his cheeks and in the sun, as well as a detailed butterfly in the scene. The knight has several color gradients and intricate spike details on his armor. The man in the mountains also has color gradients on his clothing, and the mountains depict intricate snow details.

A medium value for style strength parameter 915 may correspond to a T_{switch} value of about 0.60, resulting in medium complexity images 905 shown in the middle column. These images have simplified color palette with respect to high complexity images 900.

A high value for style strength parameter 915 may correspond to a T_{switch} value 0f 0.80 and above, indicating that most of the available layers in the image generation model that can be conditioned by the style embedding will be conditioned by the style embedding during generation. This configuration causes the image processing system to generate low complexity images 910, which are highly vectorizable. All color gradients are removed, and are replaced by simplified color bands. The butterfly from the top row is removed, and the detailed trees from the bottom row have been replaced with crudely-shaped shrubs. According to some aspects, low complexity images 910 are more suitable for conversion to vector format (“vectorization”) than the other images shown.

Generating Images with Controllable Complexity

FIG. 10 shows a diffusion process 1000 according to aspects of the present disclosure. In some examples, diffusion process 1000 describes an operation of the diffusion prior model 220 and the diffusion model 225 described with reference to FIG. 2, such as the reverse diffusion process 340 of guided diffusion model 300 described with reference to FIG. 3.

As described above with reference to FIG. 3, using a diffusion model can involve both a forward diffusion process 1005 for adding noise to an image (or features in a latent space) and a reverse diffusion process 1010 for denoising the images (or features) to obtain a denoised image. The forward diffusion process 1005 can be represented as q (xₜ|xₜ₋₁), and the reverse diffusion process 1010 can be represented as p(xₜ₋₁| xₜ). In some cases, the forward diffusion process 1005 is used during training to generate images with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , X_{T} using a Markov chain. The Markov chain gradually adds Gaussian noise to the data to obtain the approximate posterior q (x_{1:T}| x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy image 1015 and denoises the data to obtain the p(xₜ₋₁|xₜ). At each step t−1, the reverse diffusion process 1010 takes xₜ, such as first intermediate image 1020, and t as input. Here, t represents a step in the sequence of transitions associated with different noise levels, The reverse diffusion process 1010 outputs xₜ₋₁, such as second intermediate image 1025 iteratively until x-reverts back to x₀, the original image 1030. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {Π}_{t = 1}^{T} {p}_{θ} ( {x}_{t - 1} \vert {x}_{t} ) \qquad ( 2 )$$

where p(x_{T})=N (x_{T}; 0,I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data \tilde{x}, in a pixel space can be mapped into a latent space as input and a generated data x₀ is mapped back into the pixel space from the latent space as output. In some examples, x₀, represents an original input image with low image quality, latent variables x₁, . . . , x_{T} represent noisy images, and \tilde{x} represents the generated image with high image quality.

FIG. 11 shows an example of a method 1100 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains a content prompt, a style prompt, and a complexity value, where the content prompt describes an image element, the style prompt indicates an image style, and the complexity value indicates a level of influence of the style prompt. In some cases, the operations of this step refer to, or may be performed by, a design personalization apparatus as described with reference to FIGS. 1 and 2. A user may provide these inputs via a GUI interface of the design personalization apparatus. According to some aspects, the style prompt is or includes an image category, such as “scene,” “logo,” or the like. The complexity value may be inversely related with the level of influence of the style prompt.

At operation 1110, the system generates an output image that includes the image element with a level of the image style based on the complexity value. In some cases, the operations of this step refer to, or may be performed by, an image generation model as described with reference to FIGS. 2 and 5. According to some aspects, the image generation model includes a diffusion prior model configured to generate style embedding from the style prompt, and a diffusion model configured to generate the output image from the style embedding. Additional detail regarding these generation steps is provided with reference to FIGS. 3-5.

### Training

FIG. 12 is a flow diagram depicting an algorithm as a step-by-step procedure 1200 in an example implementation of operations performable for training a machine-learning model. In some embodiments, the procedure 1200 describes an operation of the training component 230 described for configuring the image generation model 215 as described with reference to FIG. 2. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which, the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. Additionally, an optimization algorithm is selected (1212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore once trained is configured to perform that task based on subsequent data received as an input and processed by the machine-learning model.

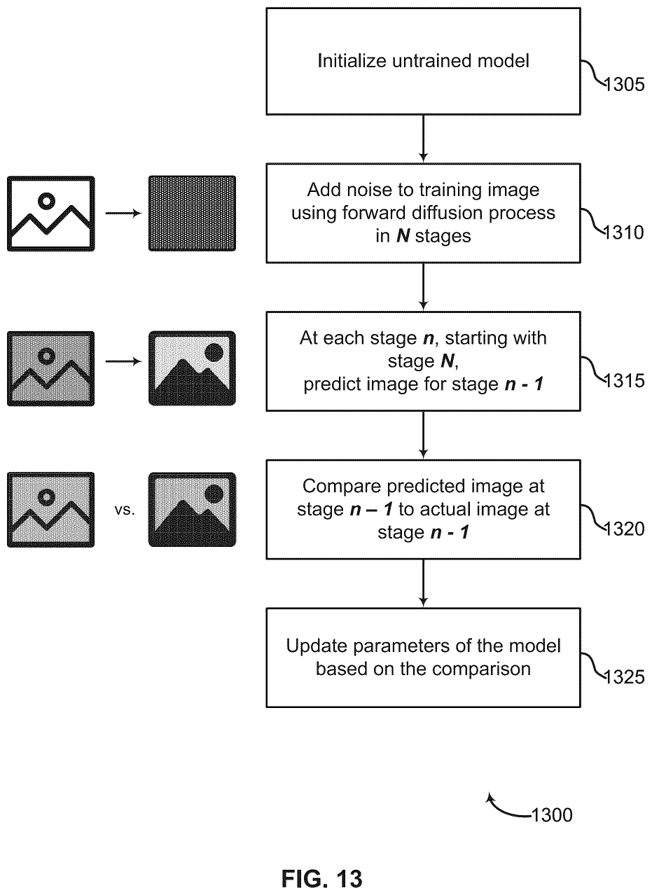

FIG. 13 shows an example of a method 1300 for training a diffusion model according to aspects of the present disclosure. In some embodiments, the method 1300 describes an operation of the training component 230 described for configuring the image generation model 215 including diffusion prior model 220 and diffusion model 225 as described with reference to FIG. 2. The method 1300 represents an example for training a reverse diffusion process as described above with reference to FIGS. 3-4 and 10. In some examples, these operations are performed by a system including a processor executing a set of codes to control functional elements of an apparatus, such as the guided diffusion model described in FIG. 3.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps or are performed in conjunction with other operations.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1315, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1320, the system compares predicted image (or image features) at stage n−1 to an actual image (or image features), such as the image at stage n−1 or the original input image. For example, given observed data x, the diffusion model may be trained to minimize the variational upper bound of the negative log-likelihood-log p_{θ}(x) of the training data.

At operation 1325, the system updates parameters of the model based on the comparison. For example, parameters of a U-Net may be updated using gradient descent. Time-dependent parameters of the Gaussian transitions can also be learned.

FIG. 14 shows an example of a pipeline for training an image generation model according to aspects of the present disclosure. The example shown includes database 1400, training data 1405, training component 1410, diffusion model 1415, diffusion prior model 1420, and image encoder 1425.

Database 1400 is an example of, or includes aspects of, the corresponding element described with reference to FIG. 1. Training component 1410 is an example of, or includes aspects of, the corresponding element described with reference to FIG. 2. Diffusion model 1415 is an example of, or includes aspects of, the corresponding element described with reference to FIG. 2. Diffusion prior model 1420 is an example of, or includes aspects of, the corresponding element described with reference to FIGS. 2 and 5.

In this example, the system obtains training data 1405 from database 1400, which includes a tuple comprising a ground-truth image, a ground-truth caption, and a ground-truth image category. The training component 1410 then finetunes diffusion model 1400 using the process described with reference to FIG. 13. This finetuning process exposes the pre-trained diffusion model to “low-complexity” and easily vectorizable images, as well as teaches the model to associate certain words from the ground-truth captions with this style.

To train the diffusion prior model 1420, the system first encodes the ground-truth image using image encoder 1425 to obtain a ground-truth image embedding. Embodiments of the image encoder 1425 include a pre-trained image encoder such as the CLIP image encoder. Then, diffusion prior model 1420 generate a predicted image embedding using a text embedding of the ground-truth caption as conditioning. The training component 1410 updates parameters of diffusion prior model 1420 based on differences between the predicted image embedding and the ground-truth image embedding. For example, training component 1410 may compute a cosine similarity between the predicted image embedding and the ground-truth image embedding, and backpropagate the cosine similarity to update values of diffusion prior model 1420.

FIG. 15 shows an example of a computing device 1500 according to aspects of the present disclosure. The example shown includes computing device 1500, processor(s) 1505, memory subsystem 1510, communication interface 1515, I/O interface 1520, user interface component(s), and channel 1530.

In some embodiments, computing device 1500 is an example of, or includes aspects of, a design personalization apparatus as described in FIGS. 1 and 2. In some embodiments, computing device 1500 includes one or more processors 1505 are configured to execute instructions stored in memory subsystem 1510 to obtain a content prompt, a style prompt, and a complexity value, wherein the content prompt describes an image element, the style prompt indicates an image style, and the complexity value indicates a level of influence of the style prompt; and generate, using an image generation model, an output image that includes the image element with a level of the image style based on the complexity value.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

Accordingly, the present disclosure includes the following aspects.

A method for image generation is described. One or more aspects of the method include obtaining a content prompt, a style prompt, and a complexity value, wherein the content prompt describes an image element, the style prompt indicates an image style, and the complexity value indicates a level of influence of the style prompt and generating, using an image generation model, an output image that includes the image element with a level of the image style based on the complexity value. In some aspects, the level of the image style comprises a balance between the content prompt and the style embedding based on the complexity value. In some aspects, the complexity value is received via a slider element of a user interface.

Some examples of the method, apparatus, non-transitory computer readable medium, and system further include determining a set of layers of the image generation model to use for generating the output image based on the complexity value, wherein the output image is generated using the determined set of layers. In some aspects, the image style comprises a vectorizable image style, and the complexity value indicates a level of detail in the output image.

Some examples of the method, apparatus, non-transitory computer readable medium, and system further include identifying an image category, wherein the output image is generated based on the image category. Some examples further include encoding the content prompt to obtain a content embedding using a text encoder. Some examples further include encoding the style prompt to obtain the style embedding using a diffusion prior model, wherein the output image is generated based on the text embedding and the style embedding.

An apparatus for image generation is described. One or more aspects of the apparatus include at least one processor; at least one memory storing instructions executable by the at least one processor; and an image generation model comprising parameters stored in the at least one memory and configured to generate an output image depicting an image element from a content prompt based on a style prompt indicating an image style, wherein the output image has a level of the image style according to a complexity value.

Some examples of the apparatus, system, and method further include a text encoder configured to encode the content prompt to obtain a content embedding. In some aspects, the image generation model comprises a diffusion prior model configured to encode the style prompt to obtain the style embedding. In some aspects, the image generation model comprises a diffusion model configured to generate the output image.

Some examples of the apparatus, system, and method further include a user interface configured to obtain the content prompt, the style prompt, and the complexity value. In some aspects, the user interface is further configured to obtain an image category, wherein the output image is generated based on the image category.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a content prompt, a style prompt, and a complexity value, wherein the content prompt describes an image element, the style prompt indicates an image style, and the complexity value indicates a level of influence of the style prompt;
determining a set of layers of an image generation model to use for generating the output image based on the complexity value; and
generating, using the determined set of layers of the image generation model, an output image based on the content prompt and the style prompt, wherein the output image includes the image element with a level of the image style that corresponds to the complexity value.

2. The method of claim 1, wherein:
the output image is generated by conditioning the determined set of layers with an embedding of the style prompt.

3. The method of claim 1, wherein:
the image style comprises a vectorizable image style, and the complexity value indicates a level of detail in the output image.

4. The method of claim 1, further comprising:
identifying an image category, wherein the output image is generated based on the image category.

5. The method of claim 1, further comprising:
encoding the content prompt to obtain a content embedding using a text encoder; and
encoding the style prompt to obtain the style embedding using a diffusion prior model, wherein the output image is generated based on the text embedding and the style embedding.

6. The method of claim 5, wherein:
the level of the image style comprises a balance between the content prompt and the style embedding based on the complexity value.

7. The method of claim 1, wherein:
the complexity value is received via a slider element of a user interface.

8. A non-transitory computer readable medium storing code for image processing, the code comprising instructions that, when executed by at least one processor, causes the at least one processor to perform operations comprising:
obtaining a content prompt, a style prompt, and a complexity value, wherein the content prompt describes an image element, the style prompt indicates an image style, and the complexity value indicates a level of influence of the style prompt;
determining a set of layers of an image generation model to use for generating the output image based on the complexity value; and
generating, using the determined set of layers of the image generation model, an output image based on the content prompt and the style prompt, wherein the output image includes the image element with a level of the image style that corresponds to the complexity value.

9. The non-transitory computer readable medium of claim 8, wherein:
the output image is generated by conditioning the determined set of layers with an embedding of the style prompt.

10. The non-transitory computer readable medium of claim 8, wherein:
the image style comprises a vectorizable image style, and the complexity value indicates a level of detail in the output image.

11. The non-transitory computer readable medium of claim 8, the code further comprising instructions executable by the processor to perform operations comprising:
identifying an image category, wherein the output image is generated based on the image category.

12. The non-transitory computer readable medium of claim 8, the code further comprising instructions executable by the processor to perform operations comprising:
encoding the content prompt to obtain a content embedding using a text encoder; and
encoding the style prompt to obtain the style embedding using a diffusion prior model, wherein the output image is generated based on the text embedding and the style embedding.

13. The non-transitory computer readable medium of claim 12, wherein:
the level of the image style comprises a balance between the content prompt and the style embedding based on the complexity value.

14. The non-transitory computer readable medium of claim 8, wherein:
the complexity value is received via a slider element of a user interface.

15. A system comprising:
a memory component; and
a processing device coupled to the memory component, the processing device configured to perform operations comprising:
obtaining a content prompt, a style prompt, and a complexity value, wherein the content prompt describes an image element, the style prompt indicates an image style, and the complexity value indicates a level of influence of the style prompt; and
generating, using an image generation model, an output image based on the content prompt, the style prompt, and the complexity value, wherein the output image includes the image element with a level of the image style based on the complexity value.

16. The system of claim 15, further comprising:
a text encoder configured to encode the content prompt to obtain a content embedding.

17. The system of claim 15, wherein:
the image generation model comprises a diffusion prior model configured to encode the style prompt to obtain the style embedding.

18. The system of claim 15, wherein:
the image generation model comprises a diffusion model configured to generate the output image.

19. The system of claim 15, further comprising:
a user interface configured to obtain the content prompt, the style prompt, and the complexity value.

20. The system of claim 19, wherein:
the user interface is further configured to obtain an image category, wherein the output image is generated based on the image category.
